(19) United States
(12) Patent Application Publication
(10) Pub. No.: US 2012/0018941 A1
(43) Pub. Date: Jan. 26, 2012

(54) DIRECT CLAMP GRIPPER AND PART ADAPTER SYSTEM FOR GRIPPER

(75) Inventor: James Thomas Buckley, Roseville, MI (US)

(73) Assignee: ACME MANUFACTURING COMPANY, Auburn Hills, MI (US)

(21) Appl. No.: 12/952,717

(22) Filed: Nov. 23, 2010

Related U.S. Application Data
(63) Continuation-in-part of application No. 12/839,805, filed on Jul. 20, 2010.

(51) Int. Cl. B25B 1/24

(52) U.S. Cl. 269/257

(57) ABSTRACT

An automated system for adapting a gripper to conform to parts having various configurations is disclosed herein. The gripper includes clamp pads having clamp surfaces for clamping protrusions on the parts. The automated system includes an actuator coupled to the gripper, a transfer mechanism engaging the actuator and moveable in response to actuations by the actuator, and a clamp block coupled to and moveable with the transfer mechanism.

### CROSS-REFERENCE TO RELATED APPLICATION

This application is a continuation-in-part of U.S. Ser. No. 12/839,805, filed Jul. 20, 2010, which is hereby incorporated by reference.

### FIELD

The present disclosure relates to robotic finishing systems and, more particularly, to direct clamp grippers and part adapter systems for grippers.

### BACKGROUND

This section provides background information related to the present disclosure which is not necessarily prior art.

Metalworking of cast metal articles such as prosthetic knee implants typically requires surface finishing such as buffing, polishing, deburring, grinding and satin finishing. Traditionally, these finishing steps were performed by hand. More recently, however, automated processing replaced most manual operations. As compared to manual finishing, automated finishing provides greater efficiency, precision, and safety.

An important aspect of robotic finishing knee implants is the need to manipulate the implant to expose all surfaces to a finishing device such as a wheel or belt. To accomplish this, the implant must be held by the robot and maneuvered to various orientations relative to the finishing device. Importantly, the robot must hold the implant against the finishing device with pressure without marring the surface of the implant when picking it up or putting it down.

One technique for enabling a knee implant to be picked up and manipulated by a robot in a finishing operation is to mount the knee implant to a metal support bar. In this technique, the knee implant is fixed to a central region of a metal bar through the use of fasteners such as screws. The bar laterally extends beyond the both outboard edges of the knee implant to provide two graspable handles for the robot. The robot may then use jaws to clamp onto one handle of the bar and manipulate the knee implant relative to the finishing device. The knee implant and bar assembly may then be set down while the robot repositions its jaws to the other graspable handle of the bar. The knee implant may then be further manipulated relative to the finishing device. Mounting a knee implant to a support bar is labor intensive and involves significant costs associated with the support bars.

A second technique for enabling robotic manipulation of a knee implant is to secure a gripper to a robot having jaws. The gripper allows the robot to directly clamp the knee implant via actuation of the jaws. One type of a conventional gripper includes two opposing clamp bars that clamp onto two posts extending from an inner surface of the knee implant. The robot positions the clamp bars normal to the outboard edges of the knee implant on opposite sides of the two posts, and then brings the clamp bars together to clamp the posts. The robot closes its jaws to bring the clamp bars together and opens its jaws to move the clamp members apart. When clamping the posts, the clamp bars extend across a cruciate gap separating two condyles of the knee implant from which the two posts extend. Using a gripper such as the one described above for finishing knee implants requires manually finishing the cruciate gap obstructed by the clamp bars during automated finishing.

Thus, there is a need for a finishing system that enables the direct clamping of knee implants while providing maximized part clearance.

### SUMMARY

This section provides a general summary of the disclosure, and is not a comprehensive disclosure of its full scope or all of its features.

An automated system for adapting a gripper to conform to parts having various configurations is disclosed herein. The gripper includes clamp pads having clamp surfaces for clamping protrusions on the parts. The automated system includes an actuator coupled to the gripper, a transfer mechanism engaging the actuator and moveable in response to actuations by the actuator, and a clamp block coupled to and moveable with the transfer mechanism.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a plan view of a robotic finishing system according to the principles of the present disclosure;

FIG. 2 is a perspective view of a part staging fixture according to the principles of the present disclosure supporting a knee implant;

FIG. 3 is a planar view of the part staging fixture of FIG. 2 supporting a knee implant;

FIG. 4 is a perspective view of a direct clamp gripper according to the principles of the present disclosure clamping a post of a knee implant;

FIG. 5 is a perspective view of the direct clamp gripper of FIG. 4 and a knee implant, with the gripper clamping a different post of the knee implant;

FIG. 6 is an exploded perspective view of the direct clamp gripper of FIG. 4;

FIG. 7 is a sectional view of the direct clamp gripper of FIG. 4 and a knee implant, with clamp pads of the gripper positioned to clamp the post;

FIG. 8 is a sectional view of the direct clamp gripper of FIG. 4 and a knee implant, with the clamp pads of the gripper positioned to release the post;

FIG. 9 is a perspective view of a part regrip fixture according to the principles of the present disclosure clamping notches in a knee implant;

FIG. 10 is a side view of a knee implant being transferred between the direct clamp gripper of FIG. 4 and the part regrip fixture of FIG. 9;

FIG. 11 is a sectional view of the part regrip fixture of FIG. 9 and a knee implant, with tabs of the regrip fixture positioned to engage the notches;

FIG. 12 is a sectional view of the part regrip fixture of FIG. 9 and a knee implant, with tabs of the regrip fixture positioned to release the notches;

FIG. 13 is a perspective view of a direct clamp gripper according to the principles of the present disclosure clamping a post of a knee implant;

FIG. 14 is a perspective view of a direct clamp gripper including a part adapter system according to the principles of the present disclosure, the gripper releasing a part adapter according to the principles of the present disclosure;

FIG. 15 is a perspective view of the direct clamp gripper of FIG. 14 clamping a part adapter according to the principles of the present disclosure;

FIG. 16 is an exploded perspective view of the direct clamp gripper of FIG. 14;

FIG. 17 is a perspective view of a portion of the direct clamp gripper of FIG. 14 clamping a post of a first knee implant and conforming to an inner surface of the first knee implant;

FIG. 18 is a perspective view of a portion of the direct clamp gripper of FIG. 14 clamping a post of a second knee implant and clamping a first part adapter, the first part adapter adapting the gripper to conform to an inner surface of the second knee implant;

FIG. 19 is a perspective view of a portion of the direct clamp gripper of FIG. 14 clamping a post of a third knee implant and clamping a second part adapter, the second part adapter adapting the gripper to conform to an inner surface of the third knee implant;

FIG. 20 is a perspective view of an adapter nest supporting a plurality of part adapters according to the principles of the present disclosure;

FIG. 21 is a perspective view of the direct clamp gripper of FIG. 4 positioned above one of the part adapters supported by the adapter nest of FIG. 20;

FIG. 22 is a perspective view of a direct clamp gripper including a part adapter system according to the principles of the present disclosure; and

FIG. 23 is a perspective view of an adapter nest engaging a plurality of part adapters according to the principles of the present disclosure.

Corresponding reference numerals indicate corresponding parts throughout the several views of the drawings.

### DETAILED DESCRIPTION

Example embodiments will now be described more fully with reference to the accompanying drawings.

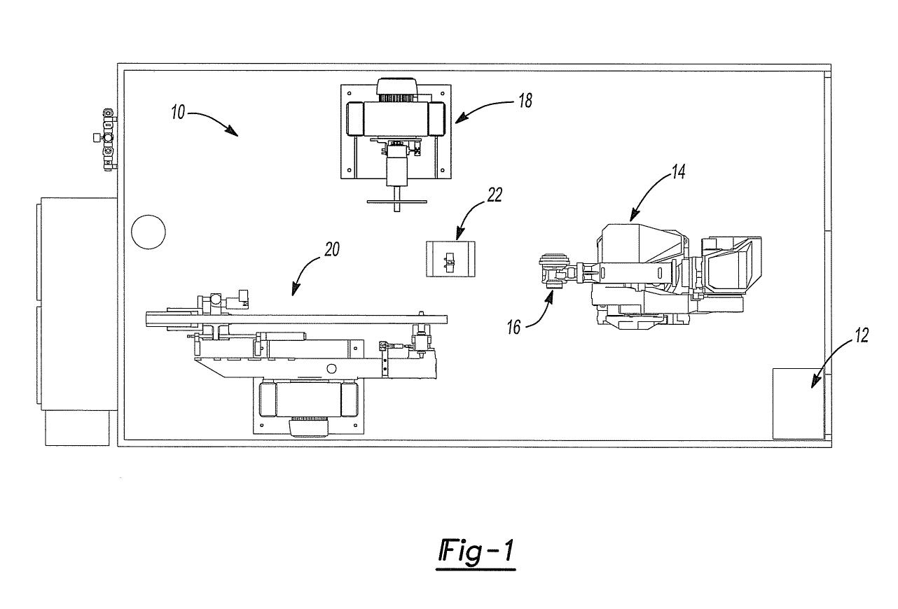

Referring now to FIG. 1, a robotic finishing system 10 used for finishing parts such as knee implants is illustrated. The system 10 includes a part staging fixture 12, a robot 14, a direct clamp gripper 16 coupled to the robot 14, a wheel finishing device 18, a belt finishing device 20, and a part regrip fixture 22. The robot 14 may be a FANUC M710iC 6-Axis robot with a 110-pound payload. The finishing devices 18, 20 may include 5 horsepower dual stacked buff heads or ultra-light front floating heads. The system 10 may include more or less finishing devices.

In operation, the robot 14 picks up a knee implant from the part staging fixture 12 and manipulates the implant relative to the finishing devices 18, 20 to perform buffing, polishing, and the like. To expose all surfaces of the implant to the finishing devices 18, 20, the robot 14 transfers the part to the regrip fixture 22 and regrips the part from an opposite side. Finishing operations are then continued.

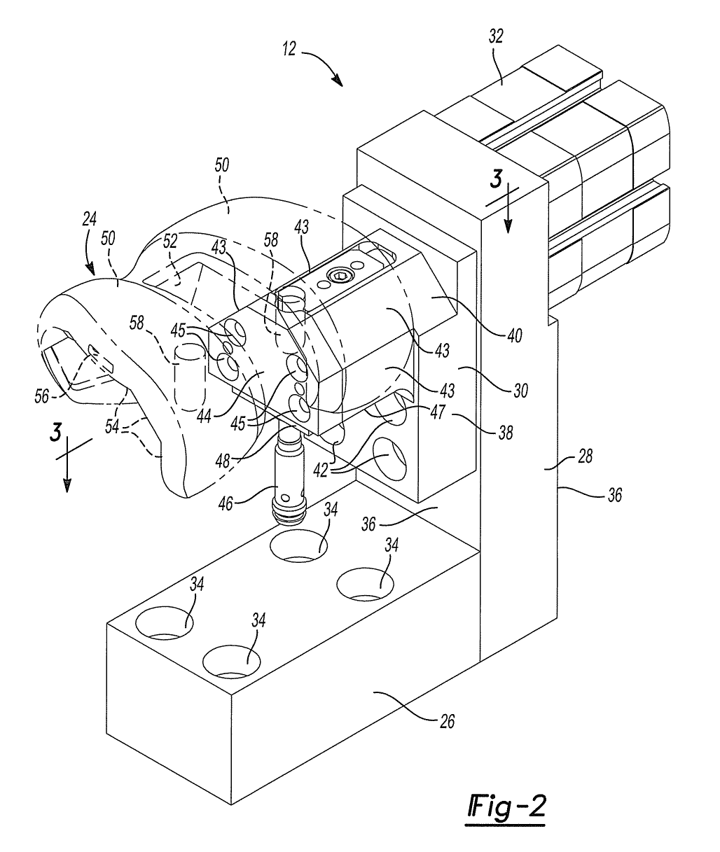

Referring now to FIG. 2, the staging fixture 12 may support a knee implant 24 both before and after the implant 24 is finished in the system 10. Although a knee implant is used throughout this description as an example of the part to be finished, the present disclosure is not limited to tooling for finishing knee implants.

The staging fixture 12 includes a mounting base block 26, a support block 28, a part nesting block 30, and an actuator 32. The mounting base block 26 includes holes 34 in which fasteners may be inserted to fix the staging fixture 12 to, for example, a bedplate. The blocks 26, 28 may include holes (not shown) in which fasteners may be inserted to fix the support block 28 to the mounting base block 26. The support block 28 includes mounting surfaces 36 on which the part nesting block 30 and the actuator 32 are mounted. The mounting surfaces 36 may include holes (not shown) in which fasteners may be inserted to mount the part nesting block 30 and the actuator 32 to the support block 28.

The part nesting block 30 includes a mounting portion 38 and an engaging portion 40. The mounting portion 38 has a rectangular shape and includes holes 42 in which fasteners may be inserted to mount the part nesting block 30 to the support block 28. The engaging portion 40 has a hexagonal shape providing outer surfaces 43. A clamp pad 44 is attached to an end of the engaging portion 40 via fasteners inserted through holes 45 in the clamp pad 44. A proximity sensor 46 is attached to an outer surface 47 of the engaging portion 40 via a sensor bracket 48. The actuator 32 may be a compact pneumatic cylinder that is single acting with a spring return or double acting with a compressed air return.

The implant 24 includes fingers or condyles 50 and a cruciate gap 52 disposed between and separating the condyles 50. The condyles 50 include inner surfaces 54, extraction notches 56 located at outboard edges of the implant 24, and one or more protrusions 58 extending from the inner surfaces 54 adjacent to the extraction notches 56. The outer surfaces 43 of the part nesting block 30 are shaped to substantially conform to the inner surfaces 54 of the implant 24. The protrusions 58 may be posts, as shown, that are integrally formed with the implant 24 or threaded into holes (not shown) provided in the implant 24. Alternatively, the protrusions 58 may be a single rectangular box disposed between the condyles 50.

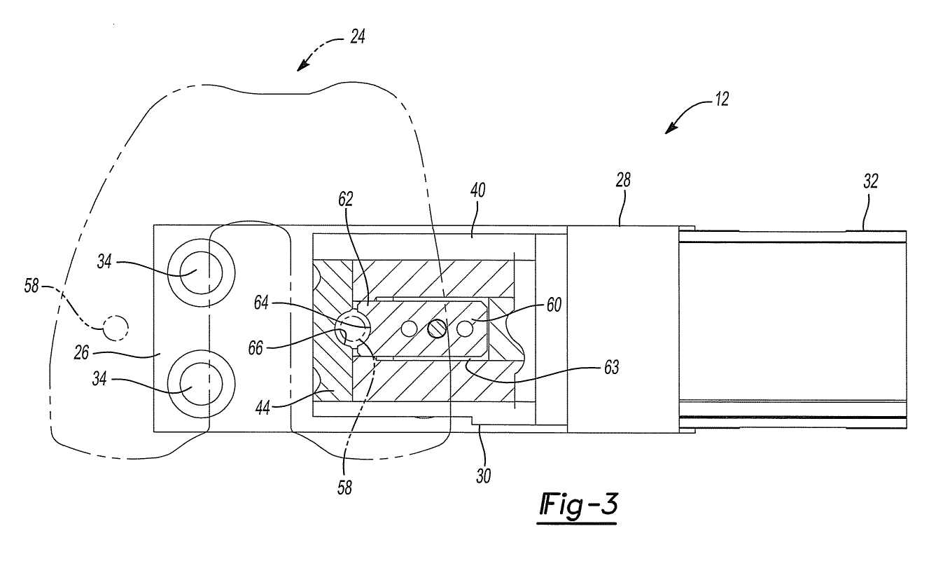

Referring now to FIG. 3, inner components of the staging fixture 12 will now be described. The inner components of the staging fixture 12 include a coupler or pushrod 60 and a clamp pad 62. The pushrod 60 couples the clamp pad 62 to the actuator 32. The pushrod 60 and the clamp pad 62 are slideable within a bore 63 extending through the support block 28 and the part nesting block 30. The clamp pad 62 includes a clamp surface 64 opposing a clamp surface 66 on the clamp pad 44.

Referring to FIGS. 2 and 3, operation of the staging fixture 12 will now be described. The staging fixture 12 engages the inner surfaces 54 of the implant 24 to locate the implant 24, and engages one of the protrusions 58 on the implant 24 to grip the implant 24. The implant 24 may be loaded onto the staging fixture 12 and unloaded from the staging fixture 12 either manually or using a gantry crane (not shown). The outer surfaces 43 of the part nesting block 30 engage the inner surfaces 54 of the implant 24 to locate the implant 24 relative to the staging fixture 12.

The staging fixture 12 grips the implant 24 by actuating the pushrod 60 toward the clamp pad 44 to engage the clamp surfaces 64, 66 on the clamp pads 44, 62 with one of the protrusions 58 on the implant 24. The staging fixture 12 may grip the implant 24 when the proximity sensor 46 detects the presence of the implant 24. The staging fixture 12 releases the implant 24 by actuating the pushrod 60 away from the clamp pad 44 to disengage the clamp surfaces 64, 66 from one of the protrusions 58.

Gripping components and operation of the staging fixture 12 may be identical to those of the gripper 16 or similar to those of the gripper 16 with only minor differences such as sizing. The gripping components of the staging fixture 12 may be sized smaller than the gripping components of the gripper 16, as the staging fixture 12 need not be able to withstand high loads exerted on the implant 24 during finishing. In view of the foregoing, the discussion below regarding the gripping components and operation of the gripper 16 also applies to the staging fixture 12.

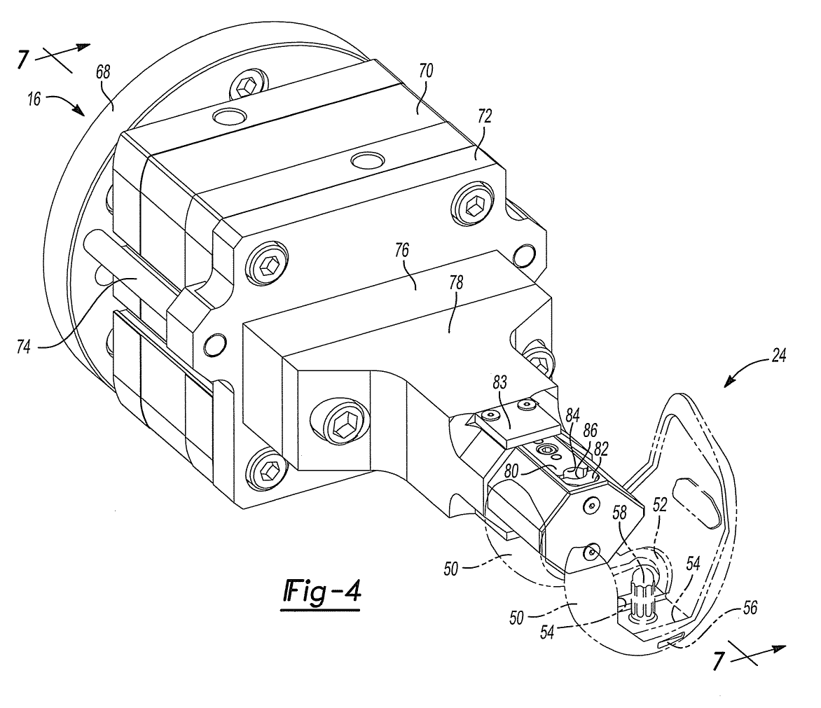

Referring to FIGS. 4 through 6, the gripper 16 includes a first adapter 68, an actuator 70, a second adapter 72, dowel pins 74, a spacer block 76, a support 78, clamp pads 80, 82, and cover plates 83. The clamp pads 80, 82 include clamp surfaces 84, 86, respectively, that are shaped to substantially conform to the contour of the protrusions 58 of the implant 24. Minor differences between the clamp surfaces 84, 86 and the perimeter surfaces of the protrusions 58 may be allowed for ease of manufacture. For example, the perimeter surfaces of the protrusions 58 may taper inward toward the respective ends of the protrusions 58, while the clamp surfaces 84, 86 may be straight.

The first adapter 68 may be a cylindrical plate having a bore 87 extending through the first adapter 68 and may include holes 88, 90, and 92 extending at least partially through the first adapter 68. The holes 88, 90, and 92 may be threaded, unthreaded, straight, countersunk, and/or counterbored depending on the fastener type to be inserted therein. Fasteners 94 are inserted into the holes 88 to couple the gripper 16 to the robot 14 of FIG. 1. The fasteners 94 may be socket head screws, as shown, and the holes 88 may be counterbored.

The actuator 70 may be a single or double acting compact pneumatic cylinder having a rectangular block shape and including a piston 96 therein. The piston 96 includes a shaft 98 including a threaded hole 100 therein. The actuator 70 further includes a bore 102 extending partially through the actuator 70 and holes 104 for fixing the actuator 70. The piston 96 is slideable within the bore 102, and travel of the piston 96 may be limited by the housing of the actuator 70. The holes 104 may be through holes.

The second adapter 72 may be a rectangular plate including a bore 106 and holes 107, 108, 109, and 110 extending at least partially through the second adapter 72. Fasteners 112 are inserted into the holes 92, 104, and 108 to couple the second adapter 72 and the actuator 70 to the first adapter 68. The fasteners 112 may be socket head screws, as shown, and the holes 108 may be counterbored through holes receiving the socket head screws. Dowell pins 74 are inserted into holes 110 and 90.

The spacer block 76 includes a bore 114 and holes 116, 118 extending at least partially through the spacer block 76. The holes 116 may be unthreaded. Dowell pins 120 are inserted into the holes 116 to align the bore 114 relative to the bores 102 and 106. A coupler or pushrod 122 is slideable within the bore 114 and couples end clamping components of the gripper 16 to the piston 96. The pushrod 122 includes a shaft 124 and a flat surface 126 including holes 128, 130 for receiving fasteners such as screws and pins. The shaft 124 of the pushrod 122 is threaded into the hole 100 of the piston 96, and a nut 132 is threaded onto the pushrod 122 to prevent the shaft 124 from backing out of the hole 100. The nut 132 may be a hex jam nut, as shown.

The support 78 may include a mounting portion 133 including holes 134 and an engaging portion 135 including an opening 136, holes 138, holes 140, and an enclosed end 139 including holes 140, and outer surfaces 142. The opening 136 exposes or provides access to the clamp surfaces 84, 86 of the clamp pads 80, 82. The engaging portion 135 may have an octagonal shape providing the outer surfaces 142 of the engaging portion 135 such that the outer surfaces 142 are shaped to substantially conform to the inner surfaces of the implant 24. The outer surfaces 142 may include a horizontal surface that is horizontal relative to ground, an angled surface that is oriented at a reflex angle relative to the horizontal surface, and a side surface that is oriented at a right angle relative to the horizontal surface.

Fasteners 144, such as screws, are inserted into holes 145 in the clamp pads 80 and into the holes 128 in the pushrod 122 to attach the clamp pads 80 to the pushrod 122. When assembled, the surfaces of the clamp pads 80 receiving the fasteners 144 may be recessed relative to the outer surfaces 142 of the support 78 to avoid contacting the implant 24 as the clamp pads 80 are actuated within the opening 136. Dowell pins 146 are inserted into holes 147 in the clamp pads 80 and into the holes 130 in the pushrod 122 to position the clamp pads 80 relative to the pushrod 122. Fasteners 148, such as screws, attach the cover plates 83 to the support 78. The cover plates 83 may cover a portion of the opening 136 that does not need to be accessible after the clamp pads 80, 82 are assembled.

Fasteners 150 are inserted into the holes 140 in the enclosed end 139 of the support 78 and into holes 153 in the clamp pads 82 to attach the clamp pads 82 to the support 78. The fasteners 150 may be screws, as shown, the holes 140 may be unthreaded, and the holes 153 may be threaded. Fasteners 152 are inserted into the holes 109, 118, and 134 to attach the spacer block 76 and the support 78 to the second adapter 72. The fasteners 152 may be socket head screws, as shown, and may be used in conjunction with washers 154.

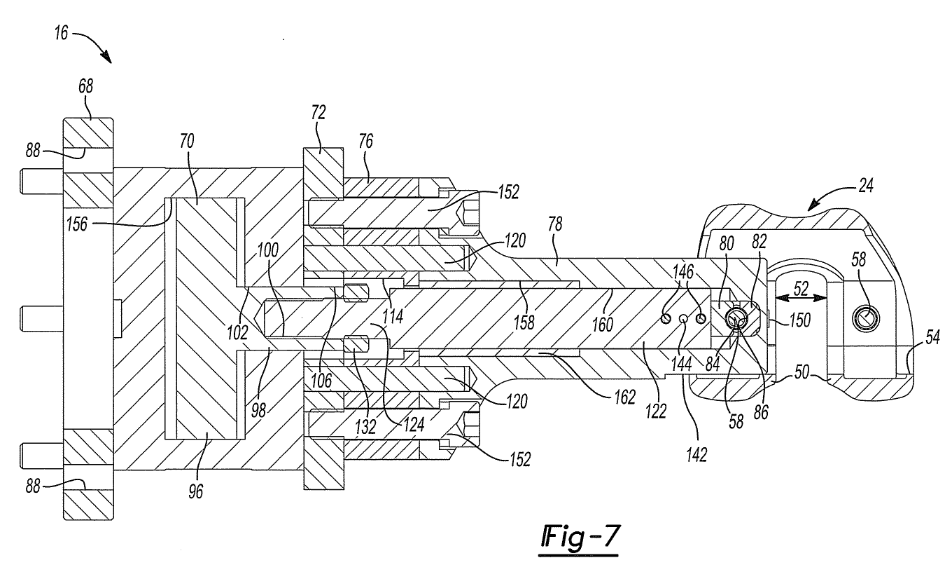

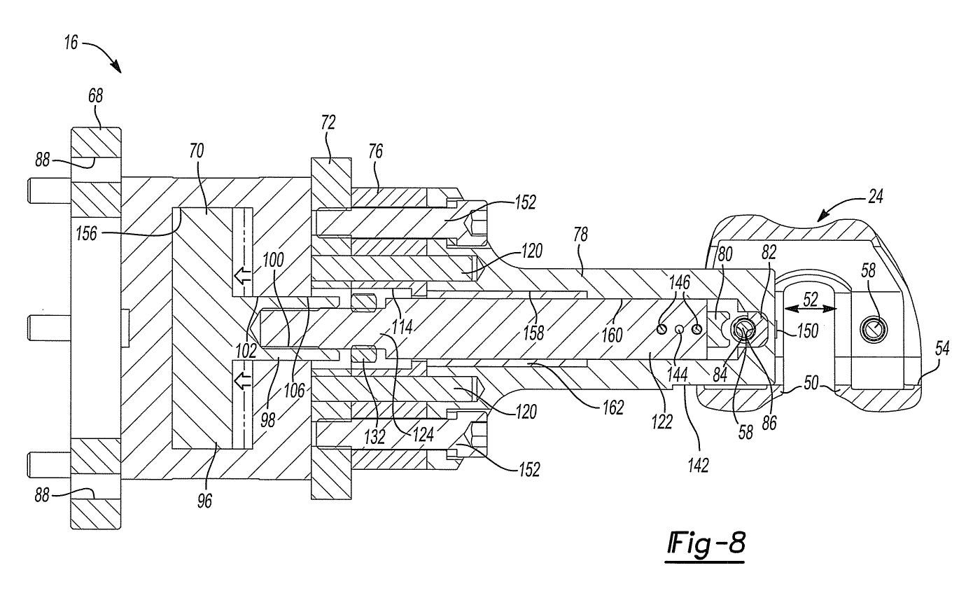

Referring now to FIGS. 7 and 8, inner detail of the gripper 16 is illustrated. The actuator 70 includes a cavity 156 to which the bore 102 extends. Travel of the piston 96 may be limited due to contact between the head of the piston 96 and the cavity 156. The support 78 includes bores 158, 160 and a bushing 162. The bore 158 may have a greater diameter than the bore 160 to accommodate the bushing 162. The pushrod 122 slides within the bore 160 and the bushing 162.

Referring again to FIGS. 4 through 8, operation of the gripper 16 will now be discussed. The gripper 16 engages the inner surfaces 54 of the implant 24 and clamps one of the protrusions 58 on the implant 24 to hold the implant 24 during finishing. Engaging the inner surfaces 54 of the implant 24 locates the implant 24 relative to the gripper 16 and facilitates clamping only one of the protrusions 58 by reducing stress levels in the implant 24 during finishing. Clamping only one of the protrusions 58 avoids the need to extend the part nesting block 30 across the cruciate gap 52 of the implant 24 when the gripper 16 clamps the implant 24, enabling automated finishing of the cruciate gap 52.

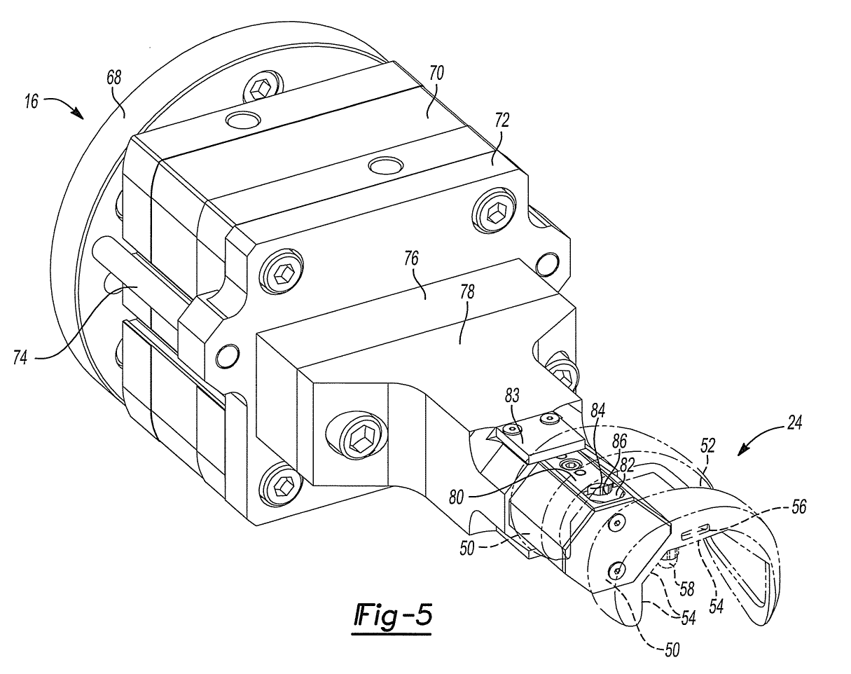

When gripping the implant 24, the robot 14 of FIG. 1 positions the clamp pads 80, 84 of gripper 16 on opposite sides of one of the protrusions 58 of the implant 24. The portion of the gripper 16 that engages the implant 24, including the outer surfaces 142 of the part nesting block 30, are symmetric about a longitudinal mid-plane extending through the gripper 16. This enables the gripper 16 to clamp either of the protrusions 58 on the implant 24, as shown in FIGS. 4 and 5, without being rotated to engage the outer surfaces 142 of the part nesting block 30 with the inner surfaces 54 of the implant 24. In turn, the robot 14 does not need the ability to rotate the gripper 16, which may reduce costs associated with the robot 14.

When the clamp pads 80, 82 are positioned on opposite sides of one of the protrusions 58 on the implant 24, the actuator 70 actuates the piston 96 to move the pushrod 122 and the clamp pad 80 toward the clamp pad 82. Travel of the piston 96, the pushrod 122, and the clamp pad 80 in this direction is stopped when the clamp surfaces 84, 86 of the clamp pads 80, 82 engage the protrusions 58, as shown in FIG. 7. The actuator 70 holds the clamp pad 80 in this position to hold the implant 24 in the gripper 16. When the clamp pads 80, 82 are not positioned about an object, travel of the piston 96, the pushrod 122, and the clamp pad 80 in this direction is limited by contact between the clamp pads 80, 82.

When releasing the implant 24, the actuator 70 actuates the piston 96 to move the pushrod 122 and the clamp pad 80 away from the clamp pad 82. Travel of the piston 96, the pushrod 122, and the clamp pad 80 in this direction is limited by contact between the head of the piston 96 and the bottom of the cavity 156 in the actuator 70, as shown in FIG. 8. However, the actuator 70 may stop travel in this direction prior to encountering this limit.

The amount by which the clamp pads 80, 82 may be separated to accommodate various protrusions 58 on the implant 24 is governed by the travel limit in the releasing direction. However, the clamp pads 80, 82 may be shaped and sized to conform to the shapes and sizes of the protrusions 58 on the implant 24. In addition, the depth to which the pushrod 122 is threaded in the piston 96 may be adjusted to accommodate protrusions having various shapes and sizes.

Since the clamp pads 80, 82 may be detached from the pushrod 122, the clamp pads 80, 82 may be replaced with clamp pads having different shapes or sizes to accommodate the protrusions 58 when gripping or releasing. In addition, the clamp pads 80, 82 may be replaced as the clamp surfaces 84, 86 on the clamp pads 80, 82 wear out. Replacing the clamp pads 80, 82 and/or varying the threaded depth of the pushrod 122 in the piston 96 to accommodate the protrusions 58 may save costs relative to other modifications to the gripper 16.

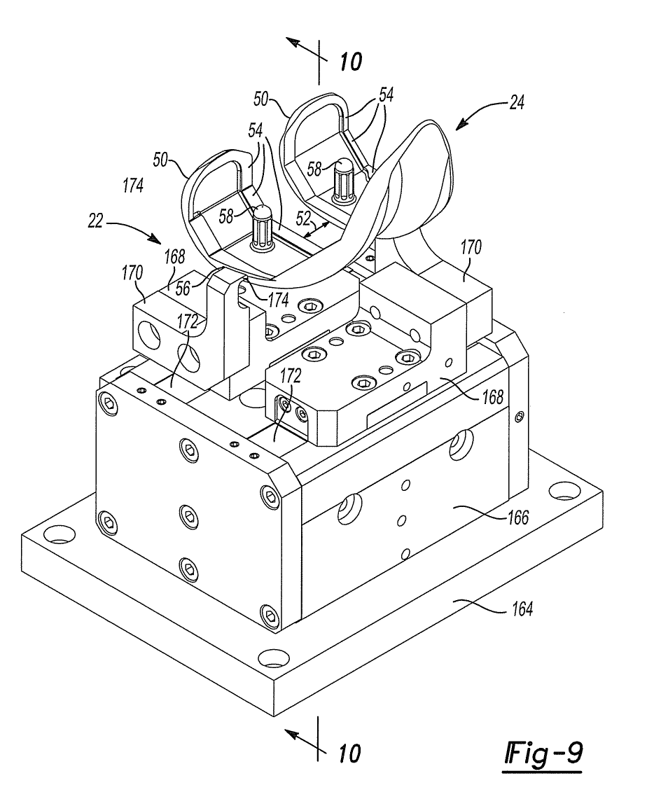

Referring to FIG. 9, the regrip fixture 22 includes a base block 164, an actuator 166, adapters 168, and fingers 170. The base block 164 may includes holes, such as those shown, in which fasteners may be inserted to fix the base block 164 to, for example, a bedplate. The actuator 166 includes slide tracks 172 to which the adapters 168 attach. The adapters 168 may be attached to the tracks 172 using fasteners, such as the socket head screws shown. The fingers 170 include tabs 174 and are attached to the adapters 168. The fingers 170 may be attached to the adapters 168 using fasteners, such as socket head screws. The tabs 174 are shaped and sized to be inserted into and engage the notches 56 in the implant 24.

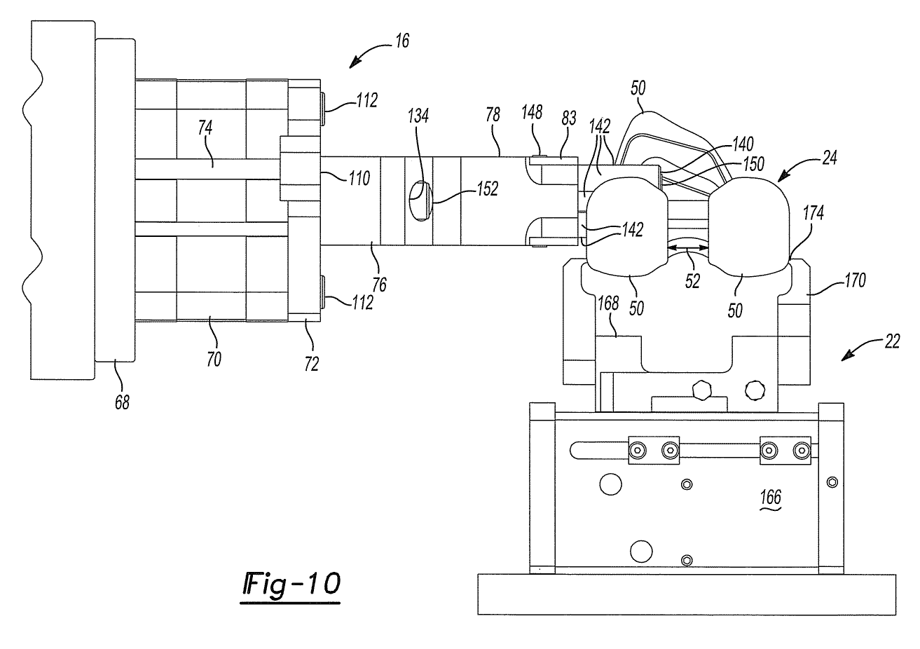

With additional reference to FIGS. 10 through 12, operation of the regrip fixture 22 will now be discussed. The regrip fixture 22 holds the implant 24 by the notches 56 in the implant 24 while the robot 14 switches from holding one of the protrusions 58 to holding another one of the protrusions 58. To enable the regrip fixture 22 to grip the implant 24, the robot 14 positions the notches 56 in the implant 24 adjacent to the tabs 174 of the fingers 170, as shown in FIG. 10.

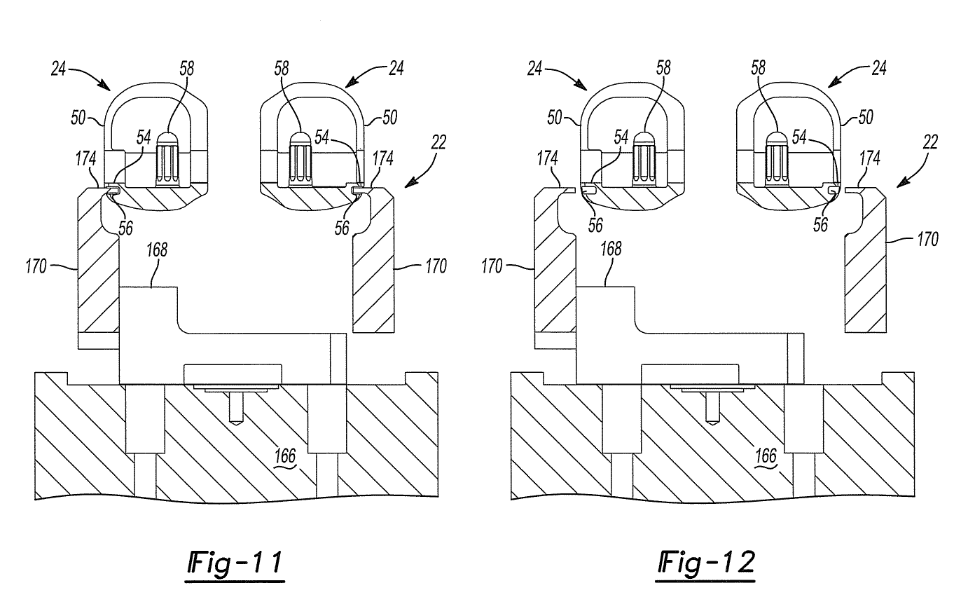

When gripping the implant 24, the regrip fixture 22 actuates the adapters 168 and the fingers 170 along the length of the track 172 to move the tabs 174 on the fingers 170 toward the notches 56 in the implant 24. The regrip fixture 22 stops actuating the tabs 174 in this direction when the tabs 174 bottom out in the notches 56, as shown in FIG. 11. In this position, the engagement between the tabs 174 on the fingers 170 and the notches 56 in the implant 24 holds the implant 24. While the regrip fixture 22 holds the implant 24, the robot 14 moves to the opposite side of the implant 24 to grab another one of the protrusions 58 on the implant 24.

When releasing the implant 24, the regrip fixture 22 actuates the adapters 168 and the fingers 170 along the length of the track 172 to move the tabs 174 on the fingers 170 away from the notches 56 in the implant 24. The regrip fixture 22 stops actuating the tabs 174 in this direction when the tabs 174 are removed from the notches 56, as shown in FIG. 12. Travel in this direction is limited by the travel limits of the actuator 166. However, the adapters 168 and/or the fingers 170 may be modified to accommodate various implant shapes and sizes.

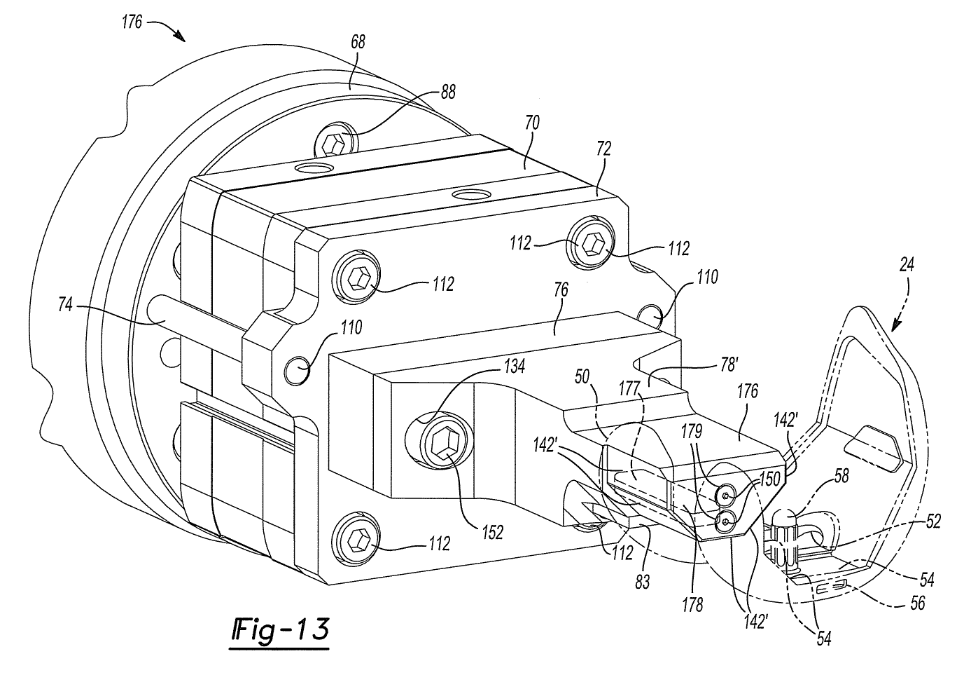

Referring now to FIG. 13, a direct clamp gripper 16′ is substantially similar to the direct clamp gripper 16 such that only differences between the grippers 16, 16′ will now be discussed. In contrast to the gripper 16, the portion of the gripper 16′ that engages the implant 24 is not symmetric about a longitudinal mid-plane extending through the gripper 16′. Thus, the gripper 16′ must be rotated as the gripper 16′ transitions between clamping the protrusions 58 on the implant 24. However, the gripper 16′ may require less material and less machining operations as compared to the gripper 16, thereby saving costs associated with the gripper 16′.

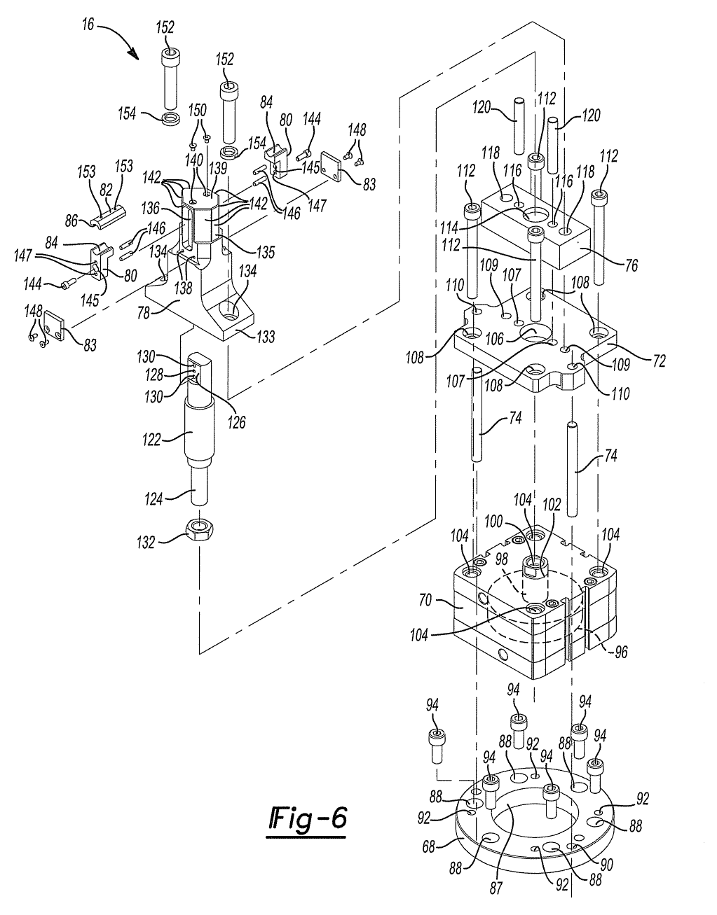

The gripper 16′ includes an engaging portion 175 including a flat surface 176, an opening 177, and an enclosed end 178. The engaging portion 175 has a hexagonal shape rather than the octagonal shape of the engaging portion 135 of FIG. 6. The flat surface 176 extends between two of the surfaces 142′ shown as parallel and vertical in FIG. 13, and the flat surface 176 is opposite one of the surfaces 142′ shown as horizontal in FIG. 13. The flat surface 176 may be positioned in the vertical direction of FIG. 13 such that the height of the two parallel surfaces 142′ is equal to the height of the two corresponding surfaces 142 of FIG. 6. The opening 177 extends only partially through the engaging portion 175, as the opening 177 does not extend through the flat surface 176. The enclosed end 178 includes holes 179 that are in different positions relative to the holes 140 in the enclosed end 139 of FIG. 6. This difference in the positions of the holes 140, 179 is due to the geometric differences between the engaging portions 135, 175.

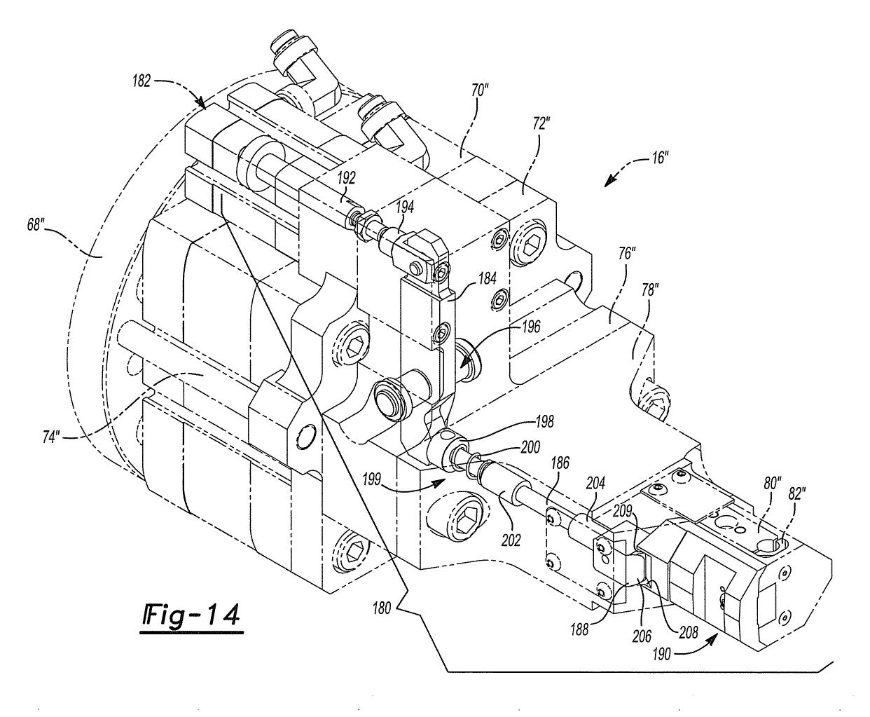

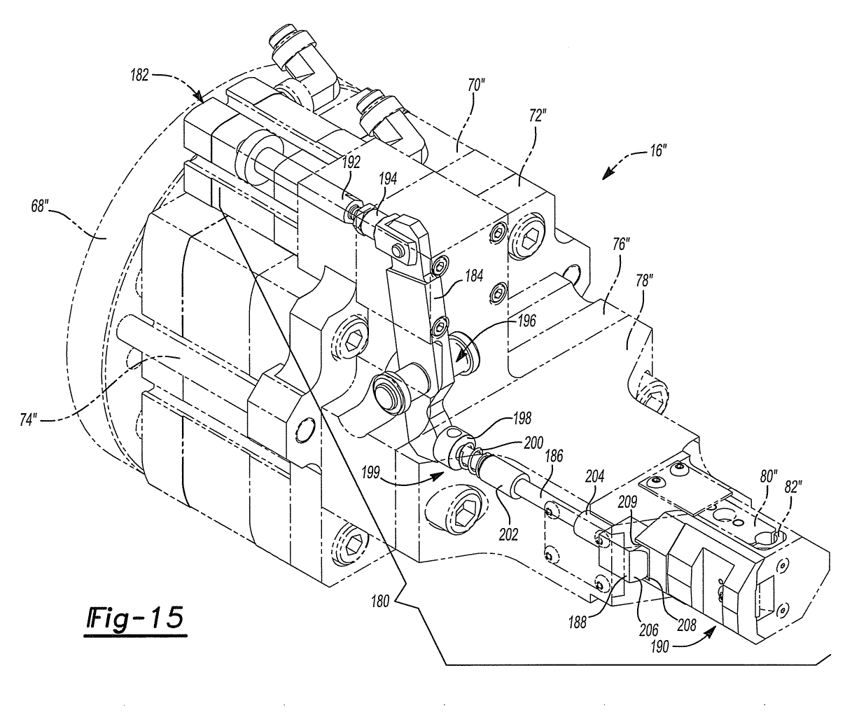

Referring now to FIGS. 14 and 15, a direct clamp gripper 16″ is substantially similar to the direct clamp gripper 16 such that only differences between the grippers 16, 16″ will now be discussed. The gripper 16″ includes at least a portion of a part adapter system 180 for adapting the gripper 16″ to conform to parts, such as knee implants, having various shapes and sizes. The part adapter system 180 includes an actuator 182, a lever 184, a pushrod 186, a clamp block 188, and a part adapter 190. The gripper 16″ may release the part adapter 190, as shown in FIG. 14, and may clamp the part adapter 190, as shown in FIG. 15.

The actuator 182 includes a piston 192. The actuator 182 may be a single acting pneumatic cylinder in which pressurized air translates the piston 192 in one direction, and a return mechanism, such as a spring, actuates the piston 192 in the opposite direction. Alternatively, actuator 182 may be a double acting pneumatic cylinder in which pressurized air actuates the piston 192 in two directions. The actuator 182 is sized to provide sufficient force to clamp the part adapter 190.

A clevis 194 couples the lever 184 to the piston 192 of the actuator 182. The actuator 182 may be extended to rotate the lever 184 about a pivot 196 in a direction away from the pushrod 186. The actuator 182 may be retracted to rotate the lever 184 about the pivot 196 in a direction toward the pushrod 186.

The lever 184 abuts the pushrod 186 and is uncoupled from the pushrod 186. The lever 184 may abut a shaft collar 198 coupled to the pushrod 186. The lever 184 pushes the pushrod 186 when the lever 184 is rotated about the pivot 196 in a direction toward the pushrod 186. A biasing mechanism 199 maintains engagement between the lever 184 and the pushrod 186 when the lever 184 is rotated in a direction away from the pushrod 186. The biasing mechanism 199 includes a spring 200 captured between the shaft collar 198 and a bearing 202.

The bearing 202 and a bearing 204 are fixed within a support 78″ of the gripper 16″. The pushrod 186 is supported by and translatable through the bearings 202, 204. The clamp block 188 is coupled to the pushrod 186 adjacent the bearing 204. The pushrod 186 moves the clamp block 188 when the pushrod 186 is translated through the bearings 202, 204.

The clamp block 188 includes an overhang 206 sized and shaped to substantially conform to a groove 208 in the part adapter 190. The gripper 16″ releases the part adapter 190 when the overhang 206 of the clamp block 188 disengages the groove 208 in the part adapter 190, as shown in FIG. 14. The gripper 16″ clamps the part adapter 190 when the overhang 206 of the clamp block 188 engages the groove 208 in the part adapter 190, as shown in FIG. 15. The groove 208 has an open end 209 through which the clamp block 188 is received.

The actuator 182 may be extended to release the part adapter 190, as shown in FIG. 14. When the actuator 182 is extended, the lever 184 rotates about the pivot 196 in a direction away from the pushrod 186. This allows the biasing mechanism 199 to translate the pushrod 186 in a direction away from the part adapter 190, thereby moving the clamp block 188 out of engagement with the part adapter 190.

The actuator 182 may be retracted to clamp the part adapter 190, as shown in FIG. 15. When the actuator 182 is retracted, the lever 184 rotates about the pivot 196 in a direction toward the pushrod 186. This causes the lever 184 to push the pushrod 186 in a direction toward the part adapter 190, thereby moving the clamp block 188 into engagement with the part adapter 190.

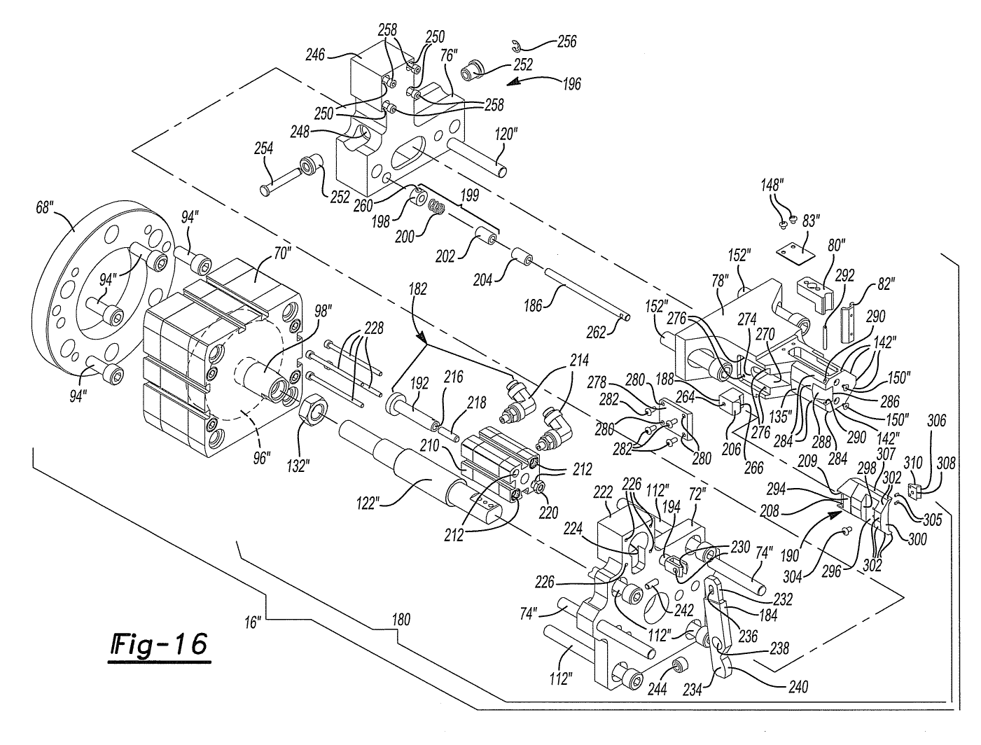

With additional reference to FIG. 16, the gripper 16″ will now be described in greater detail. The actuator 182 further includes a housing 210 having a rectangular block shape and holes 212 extending through the housing 210 along the length of the housing 210. The piston 192 of the actuator 182 includes a hole 216 partially extending through the piston 192 along the length of the piston 192. A shaft 218 threads into the hole 216, and a nut 220 threads onto the shaft 218.

A second adapter 72″ of the gripper 16″ includes an extension block 222 to which the housing 210 of the actuator 182 is mounted. The extension block 222 includes a hole 224 and holes 226 that extend through the extension block 222. The hole 224 receives the piston 192 of the actuator 182 and may be shaped similar to a key hole. The holes 226 receive fasteners 228, such as screws, which fasten the actuator 182 to the extension block 222 of the second adapter 72″.

The clevis 194 includes a threaded hole (not shown) extending at least partially through the cylindrical portion of the clevis 194 such that the clevis 194 can be threaded onto the shaft 218 after the nut 220 is threaded onto the shaft 218. The nut 220 may be tightened against the clevis 194 such that the nut 220 acts as a lock nut by maintaining the position of the clevis 194 on the shaft 218. The clevis 194 includes holes 230 extending through the U-bracket portion of the clevis 194.

The lever 184 includes a first end 232, a second end 234, a slot 236 adjacent to the first end 232, a hole 238 between the first end 232 and the second end 234, and a rounded surface 240 adjacent to the second end 234. A fastener 242, such as a pin, is inserted through the holes 230 in the clevis 194 and through the slot 236 in the lever 184 to couple the clevis 194 to the lever 184.

A bearing 244, such as a hardened steel bearing, is pushed into the hole 238 in the lever 184. The bearing 244 engages the pivot 196 about which the lever 184 rotates. The distance between the first end 232 of the lever 184 and the hole 238 in the lever 184 is greater than the distance between the hole 238 in the lever 184 and the second end 234 of the lever 184. This creates a moment arm about the pivot 196, amplifying the force transmitted from the first end 232 of the lever to the second end 234 of the lever 184, thereby allowing the actuator 182 to be sized smaller. The rounded surface 240 of the lever 184 abuts the pushrod 186.

A spacer block 76″ of the gripper 16″ includes an extension block 246 and a hole 248. The extension block 246 of the spacer block 76″ adjoins the extension block 222 of the second adapter 72″ and includes holes 250. The hole 248 in the spacer block 76″ extends laterally through the extension block 246. Sleeves 252 are inserted into the hole 248 to provide a slight clearance or line-to-line fit between the sleeves 252 and the bearing 244 in the hole 238 in the lever 184. A fastener 254, such as a pin, is inserted through the sleeves 252 and the bearing 244 to form the pivot 196 about which the lever 184 rotates. A retaining clip 256 retains the fastener 254 in the sleeves 252 and in the bearing 244. Fasteners 258, such a screws, are inserted into the holes 226, 250 to fasten the extension block 246 of the spacer block 76″ to the extension block 222 of the second adapter 72″.

The shaft collar 198 includes a hole 260 that receives a set screw (not shown), which couples the shaft collar 198 to the pushrod 186. The pushrod 186 includes a flat surface 262. The clamp block 188 includes a hole 264 extending through the clamp block 188, and the overhang 206 of the clamp block 188 includes an underside surface 266. A set screw (not shown) is driven into the hole 264 and against the flat surface 262 to couple the clamp block 188 to the pushrod 186.

The support 78″ of the gripper 16″ includes a channel 270, a recess 274 above the channel 270, and holes 276 in the recess 274. The clamp block 188 moves within the channel 270 as the actuator 182 extends and retracts. A cover plate 278 is placed in the recess 274 to cover the clamp block 188 moving in the channel 270. The cover plate 278 includes holes 280 through which fasteners 282, such as screws, are inserted to fasten the cover plate 278 to the support 78″.

The support 78″ of the gripper 16″ is configured to engage a knee implant without using the part adapter system 180. To this end, the support 78″ includes outer surfaces 284 that substantially conform to the inner surfaces of a knee implant. As with the gripper 16, the support 78″ of the gripper 16″ also includes outer surfaces 142″ that substantially conform to inner surfaces of a knee implant. However, the outer surfaces 142 only extend around a portion of the support 78″, and the outer surfaces 284 extend around the remaining portion of the support 78″.

The support 78″ of the gripper 16″ also includes adaptations that facilitate clamping the part adapter 190 onto the gripper 16″. In this regard, the support 78″ includes a groove 286 having a sloped surface 288, and includes holes 290 extending across the groove 286. The groove 286 receives a portion of the part adapter 190. The holes 290 receive a stop 292, such as a pin, which prevents the part adapter 190 from backing out of the groove 286 when the clamp block 188 is moved to engage the groove 208 in the part adapter 190. In this manner, the stop 292 maintains engagement between the part adapter 190 and the clamp block 188.

The part adapter 190 is toothbrush-shaped and includes a first flat surface 294 adjacent the groove 208, a second flat surface 296, a first projection 298, and a second projection 300. The first projection 298 and the second projection 300 partially define outer surfaces 302 that extend around the outer perimeter of the part adapter 190 and that substantially conform to inner surfaces of a knee implant. The knee implant to which the outer surfaces 302 of the part adapter 190 conform has a size and/or shape different from that of the knee implant to which the outer surfaces 284 of the support 78″ conform, as discussed below.

A fastener 304, such as a screw, and fasteners 305, such as pins, align and couple a hook member 306 to a base portion 307 of the part adapter 190. Although the hook member 306 is shown separate from the part adapter 190, the hook member 306 may be included in and/or formed integrally with the part adapter 190. The hook member 306 includes a rounded surface 308 and a sloped surface 310. The rounded surface 308 engages the stop 292 of the support 78″. The sloped surface 310 engages the sloped surface 288 in the groove 286 of the support 78″.

With additional reference to FIGS. 17 through 19, operation of the gripper 16″ will now be described in greater detail. In FIG. 17, the support 78″ of the gripper 16″ conforms to the implant 24 without using the part adapter system 180. A clamp pad 80″ is actuated toward a clamp pad 82″ to clamp one of the protrusions 58 on the implant 24 with the clamp surfaces 84″, 86″ on the clamp pads 80″, 82″. When one of the protrusions 58 on the implant 24 is clamped, the outer surfaces 142″, 284 of the support 78″ engage the inner surfaces 54 of the implant 24.

FIG. 17 shows a lateral distance L between the centerline of the clamp surfaces 84″, 86″ on the clamp pads 80″, 82″ and those of the outer surfaces 284 on the support 78″ that are generally within a plane parallel to the centerline. This lateral distance L matches the lateral distance between the centerline of the protrusions 58 of the implant 24 and those of the inner surfaces 54 on the implant 24 that are generally within a plane parallel to the centerline. This enables the outer surfaces 284 of the support 78″ to engage the inner surfaces 54 of the implant 24.

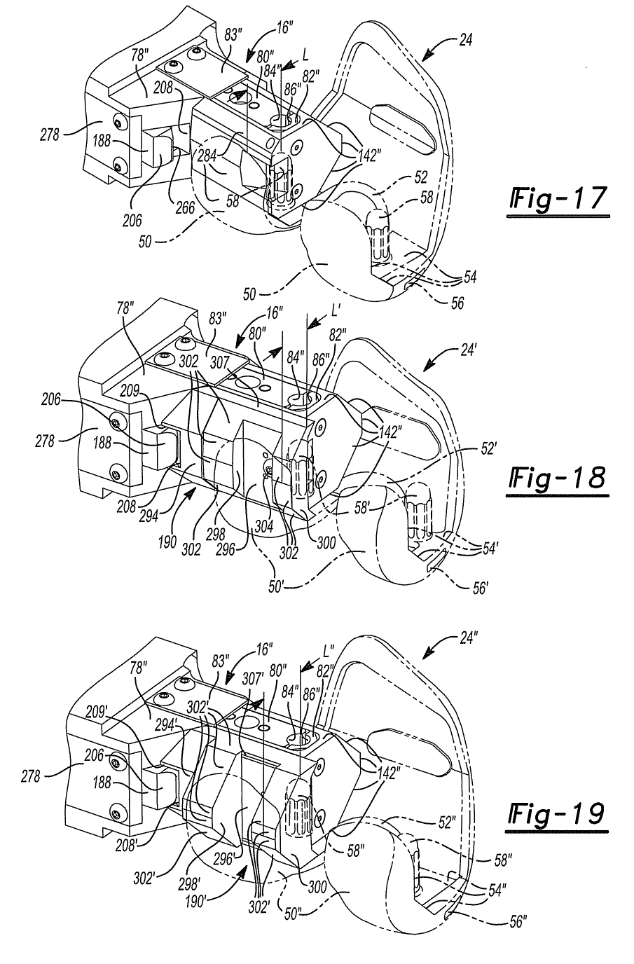

In FIG. 18, the part adapter 190 enables the gripper 16″ to conform to an implant 24′. The clamp block 188 is actuated toward the part adapter 190 to clamp the part adapter 190 with the underside surface 266 of the clamp block 188. The clamp pad 80″ is actuated toward the clamp pad 82″ to clamp one of protrusions 58′ on the implant 24′ with the clamp surfaces 84″, 86″ on the clamp pads 80″, 82″. When one of the protrusions 58′ on the implant 24′ is clamped, the outer surfaces 302 of the part adapter 190 engage inner surfaces 54′ of the implant 24′.

FIG. 18 shows a lateral distance L′ between the centerline of the clamp surfaces 84″, 86″ on the clamp pads 80″, 82″ and those of the outer surfaces 302 on the part adapter 190 that are generally within a plane parallel to the surface centerline. This lateral distance L′ matches the lateral distance between the centerline of the protrusions 58′ on the implant 24′ and those of the inner surfaces 54′ on the implant 24′ that are generally within a plane parallel to the post centerline. The lateral distance on the implant 24′ is greater than the lateral distance on the implant 24. The height of the projections 298, 300 on the part adapter 190 corresponds to this difference between the lateral distances on the implants 24, 24′.

In FIG. 19, a part adapter 190′ enables the gripper 16″ to conform to an implant 24″. The clamp block 188 is actuated toward the part adapter 190′ to clamp the part adapter 190′ with the underside surface 266 of the clamp block 188. The clamp pad 80″ is actuated toward the clamp pad 82″ to clamp one of protrusions 58″ on the implant 24″ with the clamp surfaces 84″, 86″ on the clamp pads 80″, 82″. When one of the protrusions 58″ on the implant 24″ is clamped, outer surfaces 302′ of the part adapter 190′ engage the inner surfaces 54″ of the implant 24″.

FIG. 19 shows a lateral distance L″ between the centerline of the clamp surfaces 84″, 86″ on the clamp pads 80″, 82″ and those of the outer surfaces 302′ on a part adapter 190′ that are generally within a plane parallel to the surface centerline. This lateral distance L″ matches the lateral distance between the centerline of the protrusions 58″ of the implant 24″ and those of the inner surfaces 54″ on the implant 24″ that are generally within a plane parallel to the post centerline. The lateral distance on the implant 24″ is greater than that on the implant 24′. Thus, the part adapters 190, 190′ are similarly configured except for the height of projections 298′, 300′, which is greater than that of the projections 298, 300.

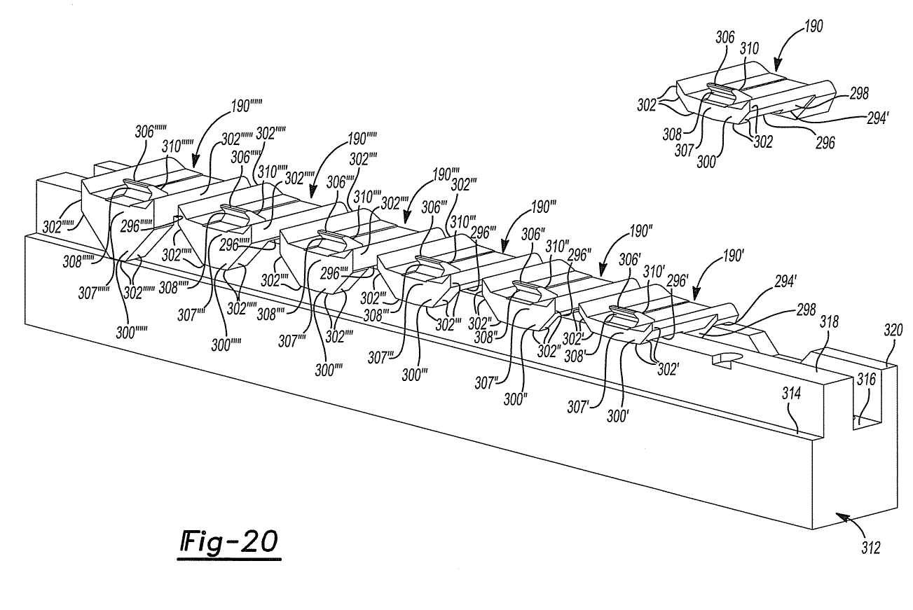

Referring now to FIG. 20, an adapter nest 312 supports part adapters 190 through 190″″″. The adapter nest 312 includes a first clearance 314, a second clearance 316, a first wall 318 having a first groove 319, and a second wall 320 having a second groove 321. While only one of the grooves 319, 321 is shown, a set of the grooves 319, 321 is disposed at each of the locations in which one of the part adapters 190 through 190″″″ is shown. Each set of the grooves 319, 321 forms a universal slot accommodating any one of the part adapters 190 through 190″″″.

The fit between the adapter nest 312 and each of the part adapters 190′ through 190″″″ is substantially similar such that only the fit between the adapter nest 312 and the part adapter 190 will now be discussed. The top surface of the first wall 318 of the adapter nest 312 engages the flat surface 294 of the part adapter 190. The groove 319 in the first wall 318 engages the head of the fastener 304 fastening the hook member 306 to the part adapter 190. The bottom surface of the groove 321 in the second wall 320 engages the flat surface 294 of the part adapter 190. The two angled surfaces flanking the bottom surface of the groove 321 engage the two angled surfaces flanking the flat surface 294 of the part adapter 190.

Thus, the grooves 319, 321 in the walls 318, 320 of the adapter nest 312 cooperate to align the part adapter 190 in the adapter nest 312 using features on the part adapter 190. The groove 319 uses the head on the fastener 304 to align the part adapter 190. In this regard, the fastener 304 serves the dual purpose of fastening the hook member 306 to the part adapter 190 and aligning the part adapter 190 in the adapter nest 312. The groove 321 uses the flat surface 294 and the angled surfaces flanking the flat surface 294 to align the part adapter 190.

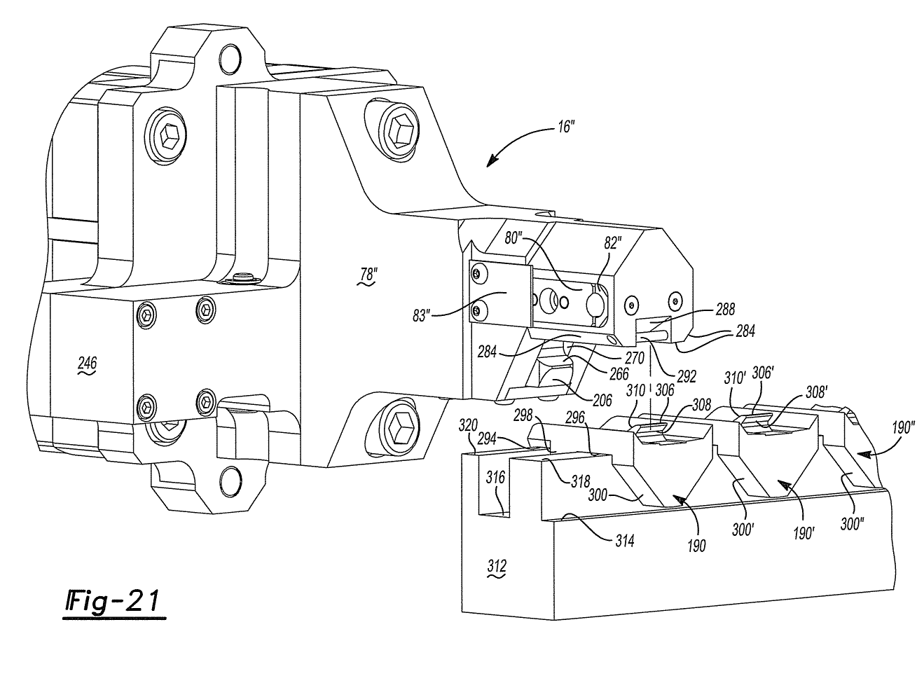

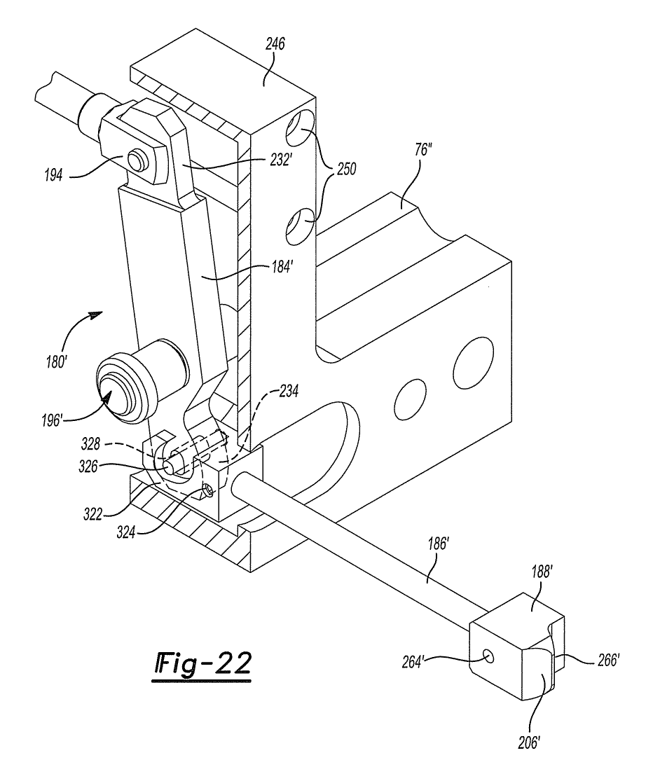

Referring now to FIG. 21, operation of the gripper 16″ when taking the part adapter 190 from the adapter nest 312 will now be described. First, the gripper 16″ is positioned above the part adapter, as shown. Second, the gripper 16″ is lowered such that the stop 292 is adjacent to the rounded surface 308 on the hook member 306. Third, the actuator 182 moves the clamp block 188 into engagement with the groove 208 in the part adapter 190, as best shown in FIG. 15. Fourth, the gripper 16″ is raised to remove the part adapter 190 from the adapter nest 312.

Referring now to FIG. 22, a part adapter system 180′ is substantially similar to the part adapter system 180 such that only differences between the part adapter systems 180, 180′ will now be discussed. In the part adapter system 180, the lever 184 abuts the pushrod 186. In contrast, in the part adapter system 180′, a lever 184′ is coupled to a pushrod 186′. Thus, the lever 184′ pulls the pushrod 186′ when rotated in a direction away from the pushrod 186′.

The part adapter system 180′ includes a clevis 322, a fastener 324, a fastener 326, and a slot 328. The clevis 322 is a u-shaped bracket sized to receive the lever 184′. A portion of the clevis 322 is not shown in order to show the fastener 326 and the slot 328. The fastener 324, which may be a set screw, fastens the clevis 322 to the pushrod 186′. The fastener 326, which may be a pin, is inserted into holes (not shown) in the clevis 322 and into the slot 328 in the lever 184′ to couple the clevis 322 to the lever 184′. The slot 328 allows a second end 234′ of the lever 184 to move vertically as the lever 184′ rotates about a pivot 196′.

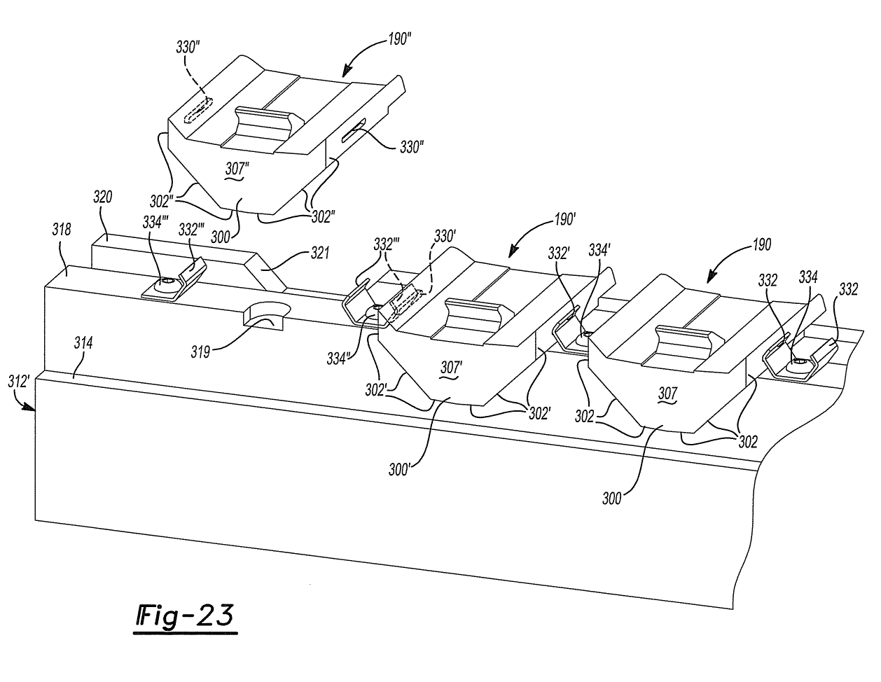

Referring now to FIG. 23, an adapter nest 312′ is substantially similar to the adapter nest 312 such that only differences between the adapter nests 312, 312′ will now be discussed. When the gripper 16″ releases the part adapter 190, gravity may be relied on to decouple the part adapter 190 from the gripper 16″. Alternatively, the part adapter 190 may include notches 330, and brackets 332, such as spring steel brackets, may be fastened to the adapter nest 312′ using fasteners 334. The brackets 332 engage the notches 330 to retain the part adapter 190 on the adapter nest 312 as the gripper 16″ is moved away from the adapter nest 312. This arrangement may be replaced with a ball detent (not shown) that functions similarly.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

What is claimed is:

1. An automated system for adapting a gripper to conform to parts having various configurations, the gripper including clamp pads having clamp surfaces for clamping protrusions on the parts, the automated system comprising:
an actuator coupled to the gripper;
a transfer mechanism engaging the actuator and moveable in response to actuations by the actuator; and
a clamp block coupled to and moveable with the transfer mechanism.

2. The automated system of claim 1, wherein the transfer mechanism includes a lever and a pushrod, the lever being coupled to the actuator and rotatable about a pivot in response to actuations by the actuator, the pushrod engaging the lever and translatable in response to rotations by the lever.

3. The automated system of claim 2, further comprising a part adapter having an outer surface substantially conforming to an inner surface of the one of the parts, the actuator being operable to clamp the part adapter by moving the clamp block into engagement with the part adapter.

4. The automated system of claim 3, wherein the actuator is retractable to cause the lever to push the pushrod and thereby move the clamp block into engagement with the part adapter.

5. The automated system of claim 3, wherein the pushrod is coupled to the lever and the actuator is extendable to cause the lever to pull the pushrod and thereby move the clamp block out of engagement with the part adapter.

6. The automated system of claim 3, wherein the pushrod abuts the lever.

7. The automated system of claim 6, further comprising a biasing mechanism fixed relative to the gripper and biasing the pushrod into engagement with the lever, wherein the actuator is extendable to allow the biasing mechanism to translate the pushrod and thereby move the clamp block out of engagement with the part adapter.

8. The automated system of claim 7, wherein the biasing mechanism includes a bearing fixed relative to the gripper and receiving the pushrod, a shaft collar coupled to the pushrod, and a spring captured between the bearing and the shaft collar.

9. The automated system of claim 3, wherein the clamp block includes an overhang and the part adapter defines a groove configured to receive the overhang.

10. The system of claim 9, wherein the groove of the part adapter has an open end and a sloped surface extending from the open end, and the overhang of the clamp block has an underside surface conforming to the sloped surface.

11. The system of claim 3, wherein the part adapter includes a hook member configured to engage a stop of the gripper when the clamp block engages the part adapter to maintain the part adapter in engagement with the clamp block.

12. The system of claim 3, wherein the part is a femoral knee implant including condyles defining the inner surface of the part to which the outer surface of the part adapter conforms.

13. The system of claim 3, wherein, when the clamp pads of the gripper clamp the protrusions on the parts, a lateral distance between a centerline of the clamp surfaces and the inner surface of the parts is different for each of the parts.

14. The system of claim 13, wherein the outer surface of the part adapter includes at least one surface generally within a plane parallel to the centerline of the clamp surfaces, and the part adapter includes at least one projection defining the at least one surface and having a height corresponding to the lateral distance between the centerline of the clamp surfaces and the inner surface of the one of the parts.

15. A part adapter system for adapting a gripper to conform to parts having various configurations, the gripper including clamp pads having clamp surfaces for clamping protrusions on the parts, the part adapter system comprising:
a first part adapter having a first outer surface substantially conforming to a first inner surface of a first part; and
a second part adapter having a second outer surface substantially conforming to a second inner surface of a second part, the second inner surface having a different configuration than the first inner surface.

16. The part adapter system of claim 15, wherein the first outer surface includes a first surface at a first lateral distance from a centerline of the clamp surfaces when the first part adapter is coupled to the gripper, and the second outer surface includes a second surface at a second lateral distance from the centerline of the clamp surfaces when the second part adapter is coupled to the gripper.

17. The part adapter system of claim 15, wherein the first part adapter has a first projection at least partially defining the first outer surface, the second part adapter has a second projection at least partially defining the second outer surface, and the first part adapter and the second part adapter have a similar configuration other than the height of the first projection and the height of the second projection.

18. The part adapter system of claim 15, further comprising an adapter nest including a plurality of slots that are each configured to receive either one of the first part adapter and the second part adapter.

19. The part adapter system of claim 18, wherein the first part adapter and the second part adapter each include a base portion, a hook member, and a fastener, the fastener fastening the hook member to the base portion and orienting the first part adapter and the second part adapter on the adapter nest.

20. A gripper for robotically finishing parts, the parts each having an inner surface with a protrusion extending from the inner surface, the gripper comprising:
a support having a first outer surface, a first groove, and a stop, the first outer surface substantially conforming to a first inner surface of a first one of the parts, the first groove defining a first sloped surface, the stop extending across the first groove;
a clamp block including an overhang having an underside surface; and
a part adapter having a second outer surface, a second groove, and a hook member, the second outer surface substantially conforming to a second inner surface of a second one of the parts, the second groove defining a second sloped surface, the clamp block being moveable to engage the underside surface of the clamp block with the second sloped surface of the part adapter, the hook member being configured to engage both the first sloped surface and the stop of the support when the underside surface of the clamp block engages the second sloped surface of the part adapter.
